(19) United States
(12) Patent Application Publication
(10) Pub. No.: US 2025/0251195 A1
(43) Pub. Date: Aug. 7, 2025

(54) HEAT TREATMENT DEVICE

(71) Applicant: HTE GMBH THE HIGH THROUGHPUT EXPERIMENTATION COMPANY, Heidelberg (DE)

(72) Inventors: Christoph ARIAANS, Heidelberg (DE); Daniel JALALPOOR, Heidelberg (DE); Robert MUELLER, Heidelberg (DE); Martin SCHULZ-DOBRICK, Braunschweig (DE)

(73) Assignee: HTE GMBH THE HIGH THROUGHPUT EXPERIMENTATION COMPANY, Heidelberg (DE)

(21) Appl. No.: 18/856,149

(22) PCT Filed: Apr. 13, 2023
(86) PCT No.: PCT/EP2023/059611

§ 371 Date: Oct. 11, 2024

(30) Foreign Application Priority Data
Apr. 14, 2022 (EP) 22168368.3

(51) Int. Cl. F27D 21/00; F27B 17/00; F27B 17/02; F27D 5/00; F27D 19/00

(52) U.S. Cl. CPC F27D 21/0014; F27B 17/0016; F27B 17/02; F27D 5/0068; F27D 2019/0003

(57) ABSTRACT

A device for heat treatment of materials and a method for thermal treatment of materials, which is carried out with the device according to the invention. Based on the invention, measurement data can be acquired with a high accuracy, where it is important that the device and the method are operated at very high temperatures. The method is preferably operated at a temperature >773.15 K (500° C.). In addition to the very high accuracy, the method also offers the possibility of acquiring and storing the measurement data during the performance of the method and then correlating it with performance data determined in downstream characterizations of the materials.

### FIELD OF THE INVENTION

The invention relates to a device for heat treatment of materials and to a method for thermal treatment of materials, which is carried out with the device according to the invention. The materials are located in spatially confined areas. The material contained in an area, which additionally possesses a materials property, is referred to hereinafter as a sample. In a preferred embodiment of the method according to the invention, the samples are heat treated simultaneously at different temperature levels in order to specifically influence the materials property. A goal is to investigate whether the heat treatment leads to an increase in efficiency for desired materials properties and then to specifically optimize them. Based on the invention, measurement data can be acquired with high accuracy during performance of the thermal treatment of materials, where it is important that the device for heat treatment and the method are operated at high temperatures. The method is preferably operated at a temperature >773.15 K (>500° C.). In addition to the very high accuracy with regard to the treatment temperature of the samples, the method also offers the possibility to correlate the measurement data during the performance of the method and also the possibility to compare the measurement data with performance data determined in downstream characterizations of the materials. Another aspect when performing the method according to the invention is how the temperature of a sample is determined if the number of temperature measuring points deviates from the number of samples.

### BACKGROUND OF THE INVENTION

The use of high-temperature furnaces for the thermal treatment of materials is part of the state of the art both in laboratory operation and in production processes. Some examples from the state of the art are set out below.

DE 103 48 811 A1 describes a muffle furnace for the thermal treatment of materials. The simultaneous thermal treatment of materials in the muffle furnace may be accompanied by the problem that volatile compounds in the individual material samples are released which may secrete into the other substances and so cause uncontrolled contamination. To prevent contamination, the samples are arranged on a common perforated plate, which is positioned with spacers above the floor in the interior of the furnace. Heat-resistant plates are arranged on the top side of the perforated plate, and divide the furnace interior into individual chambers. The materials are arranged in the different chambers. The furnace has at least one duct arranged outside the furnace that forms a connection to the interior of the furnace, the duct being connected to a fan. Air will be extracted from the interior of the furnace through the duct. If volatile compounds are released, they are removed from the furnace space by the extraction.

DE 10 2011 077 005 B4 describes a continuous furnace for the thermal treatment of substrates, which is equipped with a measuring system for acquiring measurement data. The continuous furnace has openings at two opposite sides, which represent an entry side and an exit side. On the bottom side of the interior, a support system is arranged that runs through the furnace and allows substrates to be transported through the furnace space. The measuring system for acquiring measurement data can be positioned either at the entry side or the exit side of the furnace. The measuring system is equipped with a measuring sensor arranged at the tip of the measuring system. The measuring sensor is connected to a movable drive and can be positioned at different places in the interior of the furnace to record the measurement values there. A shield is provided in the region between the linkage of the measuring sensor and the sensor tip, and protects the drive from the thermal radiation that emerges from the interior of the furnace. In addition, the sensor tip is attached to a telescopic extension, so that the sensor tip can also be positioned in the direction of the furnace interior at different locations.

A different approach to the thermal treatment of materials is described in U.S. Pat. No. 10,562,098 B2, which describes a method for high-throughput synthesis of multicomponent materials based on microsystems. The materials are inserted into the different positions of honeycomb-like containers, which are then treated by microwave radiation. Very fast heating rates can be achieved by means of the microwave radiation.

In EP 3 256 804 B1, a sintering furnace for the treatment of dental components is disclosed.

In EP 752 568 B1, an electric furnace and its use are disclosed.

DE 103 61 099 B3 discloses a method and a device for the analysis of a sample plate on which at least two samples are arranged. An impedance spectrum is measured for each of the samples in the process. In response to the measured impedance spectrum, a structure corresponding to each circuit and comprising at least one electronic device is determined. An error minimization calculation to determine starting values for the components of the respective circuit equivalent. The error minimization of at least one of the samples takes into account a theoretical impedance spectrum based on the measured impedance spectrum of the sample and involves ascertaining initial values for the heating elements and heating-element fit values for the calculated circuit equivalent. A validation for the calculated values is then ascertained, and a theoretical impedance spectrum analysis is determined by comparing at least one of the instrument adaptation values for the parameter with a reference value. The invention relates to a device for analyzing a sample plate according to the preamble of claim 1 and to a method for analyzing a more precisely defined type of sample plate.

DE 10 2012 101717 A1 discloses a method for treating at least one substrate in a process chamber of a reactor housing, namely by means of organometallic gas-phase deposition or MOCVD methods. The method involves heating multiple substrates arranged on a susceptor. The heating is done by means of a surface heating system with multiple heating elements, which are arranged below the susceptor. The device has optical temperature measurement sensors that are arranged outside the process chamber; the measurement sensors will measure the temperatures of the surface zones. The measurement values ascertained are fed to a control facility that regulates the heating output of the heating elements.

In CN 203 132 346 U, a trolley furnace for calcination of quartz ceramic articles is disclosed. The furnace space comprises on both sides a relative wall and a furnace crown, wherein the side wall with the furnace crown forms a unit and encloses it for holding and setting up, characterized in that: the trolley furnace further comprises: the temperature sensing mechanism comprises a multiplicity of temperature sensing units, and the temperature sensing units are arranged in a matrix shape, penetrating the two side walls and extending toward the insides of the two side walls; the fire hole mechanisms include fire holes with the same number as the temperature sensing units, the fire holes are arranged in a matrix shape and arranged in the two side walls.

RO 132 883 A0 discloses an arrangement of temperature sensors for characterizing the homogeneity of food heating. This allows the performance property of a microwave oven or an oven for evenly heating meals to be characterized. According to the invention, the arrangement of temperature sensors consists of a multiplicity of temperature sensors, each comprising a transducer mounted in a metallic penetration head. The temperature sensors are fixed in matrix fashion in a mounting plate. The individual temperature sensors each have a penetration head. The penetration head, which is designed for entry into the heated food, has a tip with a movable cutting device, which is pointed at a given angle. A food to be heated is taken out of the oven for measurement. With the aid of the arrangement according to the invention, the temperature at different positions within the food can be measured simultaneously at previously selected positions.

DE 10 2011 109332 A1 discloses a device and a method for treating at least one laboratory sample by means of a laboratory device and a computer program product for carrying out the method. The invention relates to a laboratory device for treating laboratory samples, in particular a laboratory device for mixing and/or tempering a liquid sample in a medical, biological or biochemical laboratory. The invention also relates to a method for treating such laboratory samples.

EP 3 539 660 A1 discloses a device and a method for storing samples at a target temperature. In particular, EP 3 539 660 A1 concerns an incubator for storing cell cultures.

DE 101 43 517 A1 discloses a device and a method in which a base plate with matrix arrangement is provided, over which a thermal camera is arranged. This DE 101 43 517 A1 describes a device for the analysis of a fluid medium, which is passed over at least one microsensor. In the analysis, the property changes are monitored by means of a thermographic detector, which is arranged in such a way that the focus of the detector is arranged above the microsensors. DE 101 43 517 A1 discloses that aluminum oxide moldings are impregnated with different metal salts, with a total of 94 different impregnated moldings being produced. The impregnated moldings are arranged in the holes of a reactor plate, wherein the reactor plate has 96 holes, which are arranged in matrix fashion. Different gas mixtures are passed over the moldings, with the thermal properties of the sample moldings being observed by means of the infrared thermal camera.

One of the objects underlying the invention is to provide a device and a method for thermal treatment of materials that make it possible to monitor the thermal treatment. At the same time, the method according to the invention where possible is also to proceed automatically.

### SUMMARY OF THE INVENTION

The subject of the present invention relates to a device for heat treatment of materials and also a method for thermal treatment of materials according to the independent claims; further embodiments of the invention are embodied in the dependent claims.

The object underlying the invention is achieved by provision of a device for heat treatment of materials which comprises a temperature-conditionable interior, a sensor matrix, a positioning system for receiving containers, a multiplicity of containers and a measuring and control unit, wherein the sensor matrix comprises a multiplicity of temperature sensors, which are arranged at different points within the temperature-conditionable interior of the device and the number of temperature sensors is ≥4, preferably the number of temperature sensors is ≥6, further preferably the number of temperature sensors is ≥8. The term “temperature sensor” refers to a transducer that acquires the temperature and converts it into an electrical signal. Signal processing and storage is performed using data processing and storage technology.

The device according to the invention is advantageous in carrying out screenings. This means that the device is designed such that a large number of samples are heat-treated simultaneously. In a preferred embodiment, the positioning device has a number of receiving positions in the range of 4 to 256, preferably the number of receiving positions is in the range of 9 to 128, in particular preferably in the range of 16 to 96.

The device according to the invention for heat treatment is designed as a lockable device. A lockable device has at least one thermally insulated door, which is equipped with a folding or sliding mechanism. For example, the sliding mechanism includes sliding elements. Preferably, the invention relates to a lockable device for heat treatment. Preferably, the device according to the invention for heat treatment is used for thermal treatment at high temperatures and the shielding of the interior of the device for heat treatment with respect to the exterior is better able, owing to the lockable door, to exclude external interference than in a continuous device.

It is preferred that the temperature sensors are arranged in a symmetrical group or at least partially in a plane surface, preferably temperature sensors are arranged in a rectangular group in the space, additionally preferably the temperature sensors are arranged in a cubic group, further preferably the temperature sensors are arranged in a plane surface, and additionally preferably the temperature sensors are arranged below the positioning system. The temperature mapping has a higher accuracy if the spatial points in the interior are uniformly acquired. With regard to the temperature sensors, it should be said that they are preferably Ni/Cr/Ni or Pt thermocouples. In addition, the spatial arrangement of the temperature sensors is referred to as a sensor matrix. Preferably, the temperature sensors are in a regular arrangement in the space, in particular preferably in a planar arrangement. The position of the temperature sensors can be clearly indicated by specifying a column index and a line index.

Regarding the dimensioning of the heat treatment device, it may be noted that it is characterized by the dimensions of the interior. The width of the interior is preferably in the range of 10 to 100 cm, in addition preferably in the range of 20 to 80 cm; preferably, the height of the interior is in a range of 5 to 50 cm, in addition preferably in a range of 10 to 40 cm; the depth of the interior is preferably in a range of 10 to 100 cm, further preferably in a range of 20 to 80 cm.

In a preferred embodiment, the invention relates to a device for heat treatment which comprises a temperature-conditionable interior, the device being lockable and having at least one thermally insulated door which is equipped with a folding or sliding mechanism, wherein the temperature-conditionable interior has a width in the range of 20 to 80 cm, a height in the range of 10 to 40 cm and a depth in the range of 20 to 80 cm.

A device for heat treatment of materials which has the temperature-conditionable interior is also referred to in the description as a furnace. Such a device is also referred to as a laboratory furnace. In general, a device for heat treatment of materials comprises one or more heating conductor elements, at least one temperature sensor and a temperature controller. The device elements are connected to one another. The actual temperature is ascertained by means of the temperature sensor. By means of the temperature controller, a setpoint temperature can be specified, with the temperature controller being designed such that it loads heating conductor elements with electrical power which is required for the temperature conditioning of the temperature-conditionable interior to a predetermined target temperature. A furnace is formed from a box-shaped housing with wall surfaces, a bottom surface and a ceiling surface. The surfaces may be divided into those surfaces which are in contact with the exterior of the device and those which are in contact with the temperature-conditionable interior of the device. The housing is constructed in such a way that the inner wall surfaces and also the bottom and ceiling surfaces of the temperature-conditionable interior are equipped with heating conductor elements, wherein one or more layers of insulation material are also arranged in the region between the inner walls and outer walls. With regard to the heating conductor elements, it may be noted that they are arranged such that a plurality of surfaces of the temperature-conditionable interior with heating conductor elements are to be simultaneously temperature conditioned, so that a plurality of wall surfaces together with bottom and ceiling surfaces are in contact with one or more heating conductor elements.

With the device according to the invention, there is an advantage over the devices known from the prior art, in which the temperature is acquired by measuring instruments which are arranged outside the furnace chamber. In the case of a thermal camera or optical sensors in the form of pyrosensors, there have to be radiation-transparent windows in the ceiling surface of the device. The production of a device with external temperature measurement in connection with radiation-transparent windows is associated with a very high cost and complexity. Heating conductors cannot be attached at the locations where the radiation-transparent windows are mounted. As a result, the heat input in the region of the ceiling surface is lower, which can lead to disruptions at high temperatures, as a horizontal temperature gradient can occur in the temperature-conditionable interior. An extreme or maximum horizontal temperature gradient exists when the temperature conditioning of a reaction chamber is carried out only via the bottom surface of a chamber, as is the case, for example, with MOCVD apparatuses used for coating substrate surfaces.

An advantage of the device according to the invention is also that the temperature sensors do not have to be arranged in the containers with the material samples, which represents a considerable technical complexity, since otherwise each individual sample material or sample container would have to be contacted with a temperature sensor. With the device according to the invention, there is also no need to place any susceptor disks into rotational movement in order to achieve uniform temperature conditioning of the surface.

The sensor matrix and the positioning system or sample containers form an independent arrangement, which are arranged in the temperature-conditionable interior and which are variable and flexible. In a preferred embodiment of the invention, the sensor matrix and the positioning system or sample containers are decoupled. Defective temperature sensors can be easily replaced. The positioning system can be populated with containers that have different dimensions and are exchangeable. Or a positioning system which is designed as a tray with recesses of a certain size can be exchanged for a different positioning system.

The positioning system (13) comprises a tray with recesses or a tray with markings. The tray can be populated with containers. The recesses or the containers have an internal diameter in the range of 1-10 cm; the surface of the positioning system comprises a measuring system, whereby the surface regions or surface points of the positioning system can be found and identified. Embodiments are also conceivable in which the containers can be arranged in the recesses of the positioning system 13 or the materials for treatment can be introduced directly into the recesses.

The positioning system is suitable for arrangement in the temperature-conditionable interior of the device, with one or more elements from the group of holder, rail, support, blocks.

The device according to the invention for heat treatment comprises a measuring and control unit, which has an electrical control facility with a database, preferably a data processing facility, further preferably a computer processor, wherein the database stores the data which describe the properties of the positioning system and which are selected from the group of total area (dimensioning) of the positioning system, recess position and recess diameter, position and diameter of individual containers, identifier numbers of individual containers; furthermore, the control device has a connection to the individual temperature sensors of the sensor matrix.

Thus, the device according to the invention also has the advantages of improved ease of handling and improved accuracy compared to devices known from the prior art.

In a preferred embodiment, the device for heat treatment is equipped with one or more additional temperature conditioning elements, which enables targeted heating or targeted cooling of a part of the interior. In a further-preferred embodiment, the additional temperature conditioning element is an element to specifically cool a part of the interior. In an even more preferred embodiment, the additional temperature conditioning element comprises a cooling fluid which is selected from the group of gases or liquids, wherein preferred gases are relatively unreactive gases. Suitable liquids can be silicone oil or water, for example. In addition, the additional temperature conditioning element may be present in an embodiment in which a liquid is employed which evaporates on the way through the cooler and absorbs energy during evaporation.

Being equipped with one or more additional temperature conditioning elements also means that these additional temperature conditioning elements are equipped with a separate temperature controller, wherein the additional temperature conditioning element or elements are controlled independently of those temperature conditioning elements that temperature-condition the temperature-conditionable interior at a predetermined target temperature.

In a preferred embodiment, the heat treatment device has a door or a hinged door, wherein it is further preferred that the additional temperature conditioning elements are arranged in the door of the heat treatment device. For example, a temperature conditioning element can be contained in the door of the device for heat treatment in the form of temperature conditioning lines through which a temperature conditioning fluid is passed. For example, the door equipped with temperature conditioning lines can be cooled with water as the temperature conditioning fluid. In a preferred embodiment, the temperature conditioning element which is arranged in the door is designed for cooling. Preferably, the door is equipped with sealing elements that can be cooled by the temperature conditioning element. Sealing elements are important for controlling the gas atmosphere in the interior of the device.

The effect achieved with the additional temperature conditioning element is that a temperature gradient is imposed on the interior of the heat treatment device that extends over the region of the temperature conditioning element to one opposite the temperature conditioning element. For example, the additional temperature conditioning element can be configured such that the temperature gradient has a value in the range of 10 to 100 K, further preferably the value is in the range of 20 to 95 K. The temperature gradient indicates the relative temperature difference present in the interior of the heat treatment device between the temperature conditioning element and the opposite point. At the same time, it is preferred that the temperature of the heat treatment device is greater than or equal to 573.15 K, further preferably greater than or equal to 773.15 K.

The additional temperature conditioning element may be rod-shaped or sheetlike, where preferably the temperature conditioning element has a parallel orientation with respect to the sensor matrix, it being also preferred that the temperature conditioning element is positioned in a lateral arrangement, insofar as it is rod-shaped. It should be noted that the combination of the additional temperature conditioning element and the sensor matrix for accurate spatial acquisition of the temperature values within the treatment zones produces a synergy effect that enables the device and the method to be used with a high flexibility in terms of high accuracy in the thermal treatment and controlled achievement of thermal differences in the treatment of the individual samples located at different positions. The lateral positioning of the additional temperature conditioning element is advantageous, since mounting of the additional temperature conditioning element in the side region is easy from a technical standpoint and since the field of the temperature gradient with respect to the base surface of the device extends from one side to the opposite side.

In a preferred embodiment, the device according to the invention has one or more suction lances and an analyzer, wherein the suction lances are connected by lines to the analyzer and wherein the end points of the suction lances are arranged in the interior of the device; preferably, the suction lances have a capillary tip, further preferably, the suction lances are not movable and made of a high-temperature-resistant material. The analyzer is used to characterize the gas flow which is transferred from the regions of the interior of the device to the analyzer by means of the suction lances. For example, the analyzer may be a mass spectrometer, gas chromatograph, or FTIR spectrometer. Preferably, the end points of the suction lances are positioned in proximity to the different containers, it being further preferred that the number of suction lances approximately corresponds to the number of sample containers. This allows the gas atmosphere in the direct spatial proximity to the material to be characterized and the data for the analysis of the gas composition to be correlated with the heat treatment of the respective samples. It is clear to the skilled person that the term “analyzer” can also mean a group of multiple analyzers. In a preferred embodiment, the connections of the suction lances to the analyzer have one or more multiport valves, it being further preferred that the analyzer and the multiport valves are coupled to the program controller of the device and are operated by the latter at least partially automatically. The device in this case is a device for heat treatment and for online analytical characterization of the heat treatment process. Thus, the heat treatment device not only offers the advantages, of flexibility and of accuracy, that a large number of samples are thermally treated at different temperatures, but also the advantage that the process of thermal treatment is monitored by analytical characterization of the gas atmosphere locally with respect to individual samples.

In another embodiment, the device according to the invention for heat treatment of materials in combination with online analytical characterization of the treatment is surrounded by a protective enclosure which can be filled with an inert gas, so that the device for heat treatment can be operated with exclusion of oxygen. In a preferred embodiment, the protective enclosure is designed in such a form that the furnace chamber is formed by metal walls and the door is provided with sealing means, so that uncontrolled egress or ingress of gas is prevented.

In addition, separation walls can be arranged on the positioning system, forming individual compartments in which the containers are positioned. The separation walls that form the individual compartments prevent the exchange of the gas atmosphere between the individual containers. In a preferred embodiment, the ends of the individual suction lances are arranged in each case in the compartments, so that the gas atmosphere withdrawn by means of the suction lance is not contaminated by the gas atmosphere of the adjacent sample containers. With further preference, the gas flow in the furnace can be replaced. For example, gas can be fed to the device via the bottom region of the interior and discharged via the ceiling region of the interior. The separation walls are made of a material that is temperature resistant. Designs for the shielding of samples in the interior of a heat treatment device are given in DE 103 48 811 A1.

The invention relates to a device and a method for heat treatment of materials, wherein the materials are examined in subsets to each of which an individual code is assigned, and wherein a single subset of material is then also referred to as an individual sample. An identifier can be assigned to each of the samples, so that it is possible to distinguish between the different samples. The positioning system which is used to receive the samples is adapted to the dimensioning of the respective interior of the heat treatment device. In a preferred embodiment, the containers have a tolerance in their receiving by the positioning system that is less than or equal to 10%, further preferably the tolerance is less than 5%, additionally preferably the tolerance is less than or equal to 2.5%. For example, this means that an individual container having a diameter in the range of 20 to 40 mm has a tolerance of 1 mm in total. If it is a container with a diameter of 20 mm, the tolerance here is 5%. If the container has a diameter of 40 mm, the tolerance here is in the region of 2.5%. This enables precise spatial positioning of the containers within the positioning system. At the same time, the positioning system can also be arranged with a high accuracy in the interior of the device for heat treatment. Preferably, the accuracy with which the positioning system is arranged in the interior of the heat treatment device is higher than 20 mm, further preferably the accuracy is higher than 10 mm, additionally preferably the accuracy is higher than 5 mm.

Preferably, in the interior of the device for heat treatment, there is a holder for receiving the positioning system.

An essential aspect of the invention is that a plurality of temperature sensors are arranged within the device for heat treatment. The temperature sensors and thus the temperature measuring sites are preferably arranged in rows and columns below the positioning system. This form of arrangement of the measuring sites results in a matrix arrangement. By specifying the line and column, a temperature sensor is thus uniquely addressed. The sensor matrix comprises at least 2×1, which means a total of two temperature sensors. In a preferred embodiment, the sensor matrix is integrated in parts of the holder. For example, in the form of cylindrical rods, which are arranged in the interior of the device, preferably below the positioning system. The cylindrical rods provide mechanical protection for the temperature sensors.

The device for heat treatment according to the invention also comprises a measuring and control facility with which the method is carried out. Thus, the invention also relates to a method for thermal treatment of materials in a device for heat treatment. In one embodiment, the method is carried out in such a way that the different materials are treated under unitary thermal conditions. This is achieved in that the method according to the invention is carried out without the application of a temperature gradient in the interior of the heat treatment device.

The temperature field within the interior of the heat treatment device is acquired by means of the sensor matrix. Since the temperature sensors are preferably arranged in a plane surface, the temperature field is spatially determined for a two-dimensional region, which is located below the positioning system. In a preferred embodiment, the sensor matrix has more than four temperature sensors, preferably the temperature sensors form a matrix which is selected from the group of 3×3 temperature sensors, 4×4 temperature sensors, 2×3 temperature sensors, 2×4 temperature sensors, 2×5 temperature sensors, 3×5 temperature sensors. The acquisition of the temperature field additionally provides that the measurement values from each individual temperature sensor are also registered as a function of time. The acquisition of the measurement values from the individual temperature sensors is a mapping, in terms of both location and time. In a further step, the individual measurement values of a time point of adjacent temperature sensors are correlated with each other, wherein the spatial regions which lie between adjacent temperature sensors are assigned a temperature value which results from the correlation.

The invention also relates to a method for heat treatment of materials in a device which comprises one of the embodiments described herein and which is connected to a database for acquisition and analysis of method parameters, the method comprising the following steps:
introduction of the materials into containers;
positioning of the filled containers in the receiving positions of the positioning system;
transfer of the positioning system populated with containers in the thermal treatment zone of the device;
storage of the positioning system in the thermal treatment zone;
acquisition of test parameters,
   wherein information on the individual materials in the form of sample identification numbers and their spatial arrangement in relation to the respective receiving positions within the positioning system is included; wherein, when the positioning system or the samples is or are stored in the treatment zone, by means of the sensor matrix, measurement data on the temperature of the individual temperature sensors are registered as a function of time.

In a preferred embodiment, the method for heat treatment of materials comprises the following steps:
recording of data on the positions of the individual temperature sensors within the temperature-conditionable interior in the database;
recording of data on the positioning system in the database, these data including the position of the individual surface of the positioning system and the dimensions of the individual containers;
storage of the positioning system in the thermal treatment zone in the case of temperature conditioning of the interior at a temperature in the range of 473.15 to 2073.15 K (200 to 1800° C.) for a selected period of time, wherein the temperature conditioning of the interior is carried out by means of a single control unit in a way such that the device is temperature conditioned at a unitary target temperature with respect to the surface of the positioning system;
registration of the temperature measurement values determined by means of the individual temperature sensors in the database, together with position datum and time datum during the performance of the temperature conditioning;
assignment of the local temperature measurement values to the individual containers whose surface region overlaps with the local temperature sensors or for which the temperature sensors are nearby, wherein for the assignment, the temperature measurement values are adapted if adjacent temperature measurement values exhibit a temperature difference, and the temperature measurement values assigned to the containers are assigned to the materials contained in the containers, the values being stored in the database under an identification number characteristic of the respective container and the material arranged therein.

Preferably, the heat treatment is carried out at a temperature in the range of 473.15 to 2073.15 K, further preferably, the heat treatment is carried out at a temperature in the range of 773.15 to 1773.15 K, additionally preferably, the heat treatment is carried out at a temperature in the range of 873.15 to 1473.15 K. The method is particularly advantageous at temperatures in the range of more than 873.15 K, as it is more difficult to control the thermal conditions accurately in heat treatment devices having the above-stated dimensions than at temperatures <873.15 K.

Preferably, the method according to the invention is carried out at temperatures >500° C., which means that the device for heat treatment of materials is designed so that it is operated at temperatures >500° C. Preferably, the invention relates to one for heat treatment of materials which is operated at temperatures >500° C. The invention further preferably relates to a device in which the surfaces of the temperature-conditionable interior are equipped with ceramic plates.

The sensor matrix is a spatial arrangement of the temperature sensors in the temperature-conditionable interior of the device, wherein the temperature sensors are preferably in a regular arrangement or in a planar arrangement. The position of a temperature sensor can be clearly indicated by specifying a column index and a line index.

The positioning system is a repository plate or a holder, which is preferably designed as a surface, wherein the positioning system is arranged in the temperature-conditionable interior of the device. Since the dimensions of the temperature-conditionable interior are specified, this specification can also be used to derive the area of the positioning system which is arranged in the temperature-conditionable interior, with the area of the positioning system being preferably in the range of 400-6400 cm² (or 0.04-0.64 m² or 4-64 dm²).

The sensor matrix is preferably a spatial arrangement of temperature sensors, preferably in a plane or in a region below the positioning system. Preferably, the temperature sensors are arranged in metal pipes, which provide mechanical protection. Preferably, the metal pipes are arranged such that they are readily accessible in the temperature-conditionable interior and are easily replaceable. The reason is that the temperature sensors are sensitive objects that show signs of wear. A particularly advantageous aspect of the device according to the invention is the flexibility in the replacement of the individual temperature sensors of the sensor matrix, since these are arranged readily accessibly in the temperature-conditionable interior. In a preferred embodiment, the sensor matrix or the temperature sensors have a distance to the positioning system which is ≤50 mm, preferably, the distance from the sensor matrix or the temperature sensors to the positioning system is ≤20 mm, additionally preferably, the distance from the sensor matrix or the temperature sensors to the positioning system is ≤10 mm, even more preferred is a distance from the sensor matrix or the temperature sensors to the positioning system of ≤10 mm, even more preferably ≤5 mm.

In the method, it is preferred that the measurement data ascertained by means of the sensor matrix are correlated, wherein the values in the space between adjacent temperature sensors are determined mathematically and the ascertained measurement data from the temperature sensors are assigned to the receiving positions and the containers arranged in the receiving positions. This method is particularly advantageous because the positioning element is replaceable and can be exchanged for a positioning element with a different number of receiving units. On the other hand, it is not necessary to adapt the number of temperature sensors, as the thermal values can be ascertained with high accuracy based on the data basis and calibration.

On the basis of the measurement values and the calculated intermediate values, the temperature field can be determined with a high temperature accuracy in the interior of the heat treatment device as a function of the site of thermal treatment as expressed by the coordinates of the matrix. The recording of temperature and the determination of intermediate values between the individual temperature sensors is registered in the program controller. This also means that information is available about the temporal temperature profile at which the individual sample materials were exposed at the respective positions. The individual temperature values on the surface of the temperature field are assigned to the materials that are positioned in the direct proximity in the containers. It follows that the treatment temperatures can be assigned to the individual materials with a very high accuracy.

In the thermal treatment of different materials under conditions that are not heat-identical, a temperature gradient which extends in the plane of the sensor matrix is generated in the interior of the heat treatment device by means of the additional temperature conditioning element. On the basis of the temperature gradient, a temperature field is generated that has a distribution of different temperature zones.

In a preferred embodiment of the method, the thermal treatment zone of the device is heated or cooled by means of the additional temperature conditioning element, preferably the thermal treatment zone is cooled by means of the additional temperature conditioning element, wherein the measurement data from the individual temperature sensors have temperature deviations ≤5K (≤5° C.), further preferably, the measurement data from the individual sensors have temperature deviations ≤1K (≤1° C.).

The method for treating the materials under conditions that are not heat-identical is carried out in an analogous manner to the treatment of the materials that are heat-identical. For non-heat-identical conditions, the temperature of the temperature field is determined and the individual sample materials arranged in the containers are assigned a temperature value which results from the determination of the measured and the calculated temperature values.

An advantage in carrying out the method according to the invention is that a predetermined number of materials can be simultaneously treated at different temperature levels. By means of the method according to the invention, the temperature conditioning of materials can be accelerated, since the temperature conditioning simultaneously means that it is unnecessary to operate multiple devices in parallel or to carry out processing in multiple runs. When using the method according to the invention, energy can be saved due to the improved efficiency. It is also clear that the method according to the invention is limited to the temperature conditioning of materials at laboratory scale.

In a further method step, the method is improved by measuring the temperature field of the furnace by means of the sensor matrix under a given set of parameters. The measuring and control program then calculates the temperature or the temporal profile of the temperature at the position of all containers, and also of the samples contained therein, in the case where the containers are loaded with samples.

Thus, on the basis of the method according to the invention, it is possible to acquire the accuracy in the temperature of the heat treatment of the individual containers and of the materials contained therein in a very accurate and reproducible manner. The measurement values acquired are stored in the program controller; the storage of measurement values also provides for the user to be displayed values for the accuracy of the performance of thermal treatments based on the basis of comparison values.

On the basis of an optimization algorithm, the device and the method are able to provide the user with method information on the accuracy of the method, which is registered in the database, or the device and the method can suggest to the user parameters that lead to an improvement in the accuracy in the performance of the thermal treatment. For example, the improved accuracy can be achieved by ascertaining, for a defined parameter space with respect to heat treatment of materials, those positions within the positioning system that have a high accuracy and the appropriate diameters of containers to achieve a desired accuracy. Preferably, the diameter of a single container is small in relation to the temperature gradient that passes through this container, wherein temperature gradient and diameter of the containers can be selected. For example, the temperature gradient can be in the range of 0.5 to 2 K/cm. In the direction of the gradient, the temperature rises along the section of the line in the plane of the furnace surface in which the containers containing the samples are positioned.

The device according to the invention is characterized in that a temperature field is acquired with high accuracy by means of a sensor matrix in the interior of the device. With regard to the implementation of the method, a synergy effect is given, which is based on the fact that the method according to the invention comprises an integration of calibration data or an integration of test data which are used as calibration data, or both calibration data and test data.

The device for heat treatment is characterized by an operating range which is set by the performance property of heating elements and control electronics. The operating range results in the minimum and maximum temperature values that are reached in the thermal treatment zone. To carry out the calibration, the interior of the device or the thermal treatment zone is stored at different temperature values (hereinafter also referred to as setting values or setpoint values) covering the range between minimum and maximum temperature values, and the local temperature is then recorded in each case by means of the temperature sensors as a function of the respectively selected setting value. For example, a device for heat treatment can be characterized by an operating range of 773.15 to 1273.15 K (500° C. to 1000° C.), so in the operating range at a total of eleven predetermined setpoint value temperatures, each at a distance of 50 K, temperature data are recorded by the program controller and stored in the associated database. Preferably, the distance of the setting values for recording the temperature data in carrying out the calibration is ≤50 K, in particular ≤20 K, further in particular ≤10 K, additionally preferably ≤5 K.

In a preferred embodiment, the device for heat treatment also comprises an additional temperature conditioning element with which a thermal gradient field or a temperature gradient within the thermal treatment zone can be generated. The terms “thermal gradient field” and “temperature gradient” are used synonymously here. In a preferred embodiment, calibration is performed in the presence of a thermal gradient field. The size or range of the thermal gradient field depends on the individual configuration of the device, which is dictated by the respective setpoint value temperature and performance characteristics of the additional temperature conditioning element. Preferably, the thermal gradient field over the treatment zone has a value that is ≥10 K, in particular ≥25 K, further in particular ≥50 K, even more preferably ≥60 K.

The additional temperature conditioning element is not fixed in any way as far as the concrete design is concerned. Preferably, the additional temperature conditioning element is characterized by a simple structure and robustness. A simple structure is characterized by the fact that the control dynamics are only low. With respect to the additional temperature conditioning element, it should be noted that the additional temperature conditioning element may include liquid cooling.

Preferably, the method comprises the recording of calibration data in the presence of a temperature gradient. For example, the additional temperature conditioning element is operated with a defined cooling power and at the same time the setpoint value temperature is set to different temperatures of the operating range of the device, in order to record the corresponding local temperature data with the sensor matrix with the program controller and to store these data in the database.

When performing the method, thermal measurement data can also be recorded by the program controller during thermal treatment of samples and stored in the database, and are then used as calibration data. The distinction between the concepts of measurement data and calibration data is that the acquisition of the calibration data is carried out with a higher systematics, where the entire operating range is set for all temperatures. Measurement data can be acquired in a narrower temperature range that only concerns temperatures in a selected operating range. In principle, the temperature measurement data for the various specified parameters are acquired with high accuracy and stored in the database.

The method preferably comprises an optimization algorithm and a program controller which provides a selection of parameters from the group of the number of samples to be subjected to a thermal treatment, the amount of samples, and the (absolute) value of the target temperature at which the thermal treatment is to be carried out, and the magnitude of the accuracy, the accuracy being given by ΔK or delta in kelvins. In a further embodiment, the method also comprises the specification of the temperature range, provided that the samples are to be simultaneously treated in a thermal gradient field at different temperatures.

The program controller analyzes the measurement data contained in the database and uses the optimization algorithm to determine the experimental parameters required to perform the method in order to implement parameters selected by the user.

The positions to be selected to achieve the desired accuracy and the required setting temperature of the furnace for that purpose can be predicted by the optimization algorithm for any (even previously unused) positions (configurations).

The accuracy can also be improved by proposing suitable setting temperatures for the temperature conditioning system and/or the additional temperature conditioning element. The proposal can be made by providing a selection. In a preferred embodiment, the program controller is configured such that it provides a selection by which the accuracy can be specified by a user, or the program controller can make suggestions to the user. The temperature conditioning system comprises setting the temperature of the device and also setting the temperature and/or the required cooling power of the additional temperature conditioning element.

The prediction here does not depend on the number and positions of previously defined containers, but can be extended to different arrangements and sizes of containers by means of appropriate correlation.

In a preferred embodiment, the method comprises steps as follows: Positioning of the samples at a position ascertained from the data from the database or from the sensor matrix measurement values so as to thermally treat a single sample or a plurality of samples at a desired temperature.

In a preferred embodiment, the method comprises the following steps: Temporally staggered positioning of the samples at multiple positions ascertained from the data from the database or from the sensor matrix measurement values so as to thermally treat a single sample or a plurality of samples at a desired temperature and with a temporally staggered temperature profile.

Preferably, the measurement data ascertained by means of the sensor matrix are correlated, wherein the values in the space between adjacent temperature sensors are determined mathematically and the ascertained measurement data from the temperature sensors are assigned to the receiving positions and the containers arranged in the receiving positions.

An embodiment of the method according to the invention is represented in the workflow plan shown in FIG. 10. Thus, the invention also relates to a workflow plan which is carried out in combination with the device according to the invention, wherein it is preferred that the workflow is integrated into the program controller.

The method may comprise a database containing fixed and variable structural parameters of the device. The fixed structural parameters include the size of the area of the positioning system, the number of temperature sensors on the sensor matrix which are arranged in the plane of the positioning system, the position of the individual temperature sensors, possibly an additional temperature conditioning element. The area of the positioning system is assigned to a coordinate system, where the area is divided into individual area elements and the positions of the individual area elements are stored in the database. For example, in the form of index numbers for lines and columns. The variable structural parameters include the size of the individual containers, the amount of sample material stored in a single container during the thermal treatment. In addition, the database may include process data, where the process data comprises temperature values which were generated and measured for specified operating parameters.

In a preferred embodiment of the method, a selection of process parameters is provided to the user by the program controller and the user can select the process parameters desired by the user. Preferably, the process parameters are provided by means of a graphical user interface.

In a preferred embodiment of the method, the selection option also offers the user the ability to specify a configuration for carrying out the method for thermal treatment of materials.

A preferred aspect of the method is that the evaluation additionally also includes comparison with data or information obtained from a database that was not obtained during the performance of the method or in the course of a previous performance of the method; in a further-preferred embodiment, the evaluation is carried out with incorporation of a computer system which is equipped with an intelligent search system, which in the evaluation proposes independent analysis suggestions for the optimization of materials. Preferably, the device comprises a computer program for performing a method, which is also linked to a relational database. Preferably, the method also comprises a program having an algorithm which is capable of comparing the collected data, wherein it is preferred that the device and the method are integrated into a digital infrastructure of the user.

With regard to the optimization of the accuracy of the device according to the invention, it is also taken into account that the plate of the positioning system is made of a material having a mid-level thermal conductivity. Preferably, this comprises steel 50 Wm⁻¹K⁻¹, iron 117 Wm⁻¹K⁻¹, corundum ceramic 49 Wm⁻¹K⁻¹ with a thermal conductivity of 40-100 Wm⁻¹K⁻¹.

In a preferred embodiment, the device and the method are utilized for producing materials from the group of catalysts, battery materials, high-performance ceramics, inorganic semiconductor materials.

With regard to the containers, it may be noted that they are crucibles or receptacles made of metal or ceramic or comprising metal or ceramic as a constituent. Metal and ceramics can also be included.

These and other features are elucidated by the description of figures that follows.

### BRIEF DESCRIPTION OF THE FIGURES

FIG. 1 shows a schematic representation of a device for heat treatment in an embodiment with a hinged door 21, which is equipped with locking elements, wherein a sensor matrix 3 is arranged in the interior of the furnace space;

FIG. 2 shows a schematic representation of a positioning system 13, which is equipped with thirty-six containers 15 arranged in the form of a 6×6 matrix; below the positioning system, a plurality of temperature sensors 4, 4′, 4″ are shown;

FIG. 3 shows a schematic representation in which the positioning system, which is equipped with containers, is arranged in the interior of a heat treatment device;

FIG. 4 shows a schematic representation of a region of a heat treatment device, wherein the interior and the attachments are shown;

FIG. 5 shows a schematic representation of the method, in which the device according to the invention is connected to a computer controller and database and is integrated into a process sequence. The process parameters for calibration and for performance of the method are registered in the database and made available to the user as in an optimization circuit for further method performances;

FIG. 6.a shows a schematic representation in the form of a sectional drawing, the orientation of which runs parallel to the bottom surface of the furnace interior, wherein an overlay of positioning system with a 5×5 matrix and sensor matrix with 4×4 temperature sensors is shown;

FIG. 6.b shows a schematic representation of the sectional drawing reproduced in FIG. 6.a, but the positioning system is equipped with 6×6 receiving positions;

FIG. 7.a shows a schematic representation of a sectional drawing of the furnace interior analogous to the representation given in FIG. 6.a, wherein, however, an additional temperature conditioning element 27 is contained, which is arranged to the side of the positioning system 13;

FIG. 7.b shows a schematic representation of a sectional drawing of the furnace interior analogous to the representation given in FIG. 6.b, wherein, however, an additional temperature conditioning element 27 is contained, which is arranged to the side of the positioning system;

FIG. 8.a shows a schematic representation of a temperature field of the furnace interior with the ascertained/measured temperature values, which were determined for the individual fields of the 6×5 matrix;

FIG. 8.b shows a schematic representation of the temperature field of the furnace interior, which is shown in FIG. 8.b, in which the positions of temperature sensors or intermediate temperatures are also drawn in;

FIG. 9 shows a schematic representation in the form of a three-dimensional representation of the temperature profile in the z-axis with respect to the surface fields of the temperature field in the x,y plane on which the containers with the samples are positioned;

FIG. 10.a shows the calibration curves for the interior of the device at different measurement points: during calibration, the temperature was increased in increments of 20 K, set to nine different setpoint temperatures on the x-axis (horizontal axis), set via the central temperature measurement sensor of the device, in the range of 1003.15 K to 1163.15 K; plotted in the vertical direction (y-axis) is the measured temperature for four different positions in the interior of the device (temperature is reported in the unit of kelvins);

FIG. 10.b shows a magnified detail for a single position of one of the calibration curves shown in FIG. 10.b, in a specific temperature window. (Temperature is reported in the unit of kelvins).

Further features and advantages of the methods of the invention and of the device are apparent from the figures and from the accompanying description of figures. It will be apparent that the features which have been mentioned above and those which are still to be elucidated below can be used not only in the combination specified in each case but also in other combinations or on their own without leaving the scope of the present invention. Working examples of the invention are shown in the figures and are described in detail hereinafter.

### DETAILED DESCRIPTION OF ILLUSTRATIVE EMBODIMENTS

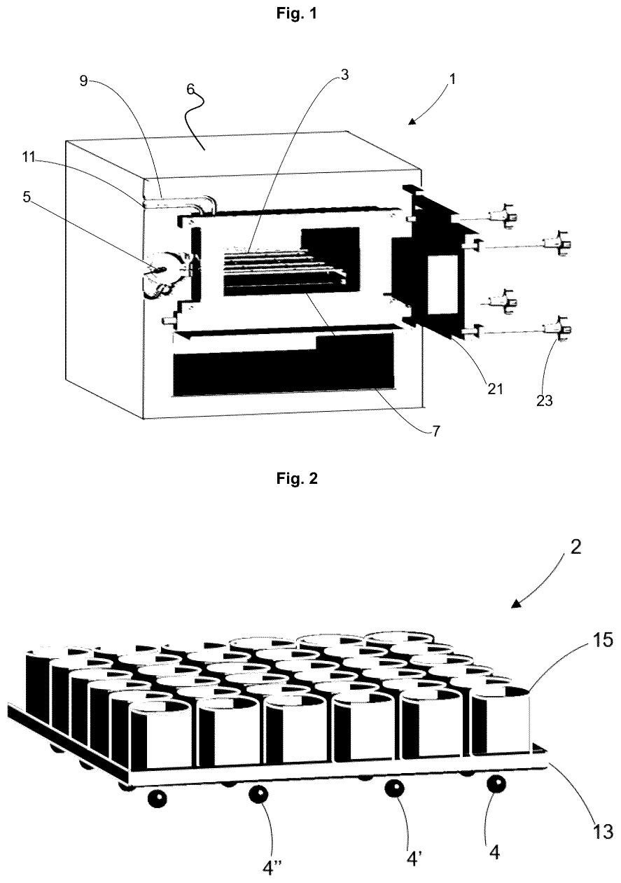

In FIG. 1, the device 1 of the invention for heat treatment is shown in the form of a high-temperature furnace 6, which has a hinged door 21, which is in the open state. The temperature sensors 3 are contained in four metal rods or metal tubes. The four metal rods or metal tubes are arranged above the base surface and form a sensor matrix which has a sheetlike orientation. The metal tubes protect the temperature sensors from damage. At the same time, the device has an additional temperature conditioning element 7 that is arranged parallel to the metal rods. In the present case, the additional temperature conditioning element 7 is equipped as a cooling element, through which a cooling fluid is passed. The supply lines for the coolant and the temperature sensors are marked in the outside region with the reference signs 9 and 11.

In FIG. 2, the schematic representation of a positioning system 2 with containers is shown, wherein the baseplate is marked with the reference sign 2 and the containers with the reference sign 15. Below the baseplate of the positioning system 13, the temperature sensors 4, 4′, 4″ are shown, which here have a matrixlike arrangement that is symmetrical. In FIG. 2, a sensor matrix with 4×4 temperature sensors, thus 16 temperature sensors, is shown and 6×6 sample containers, thus 36 sample containers.

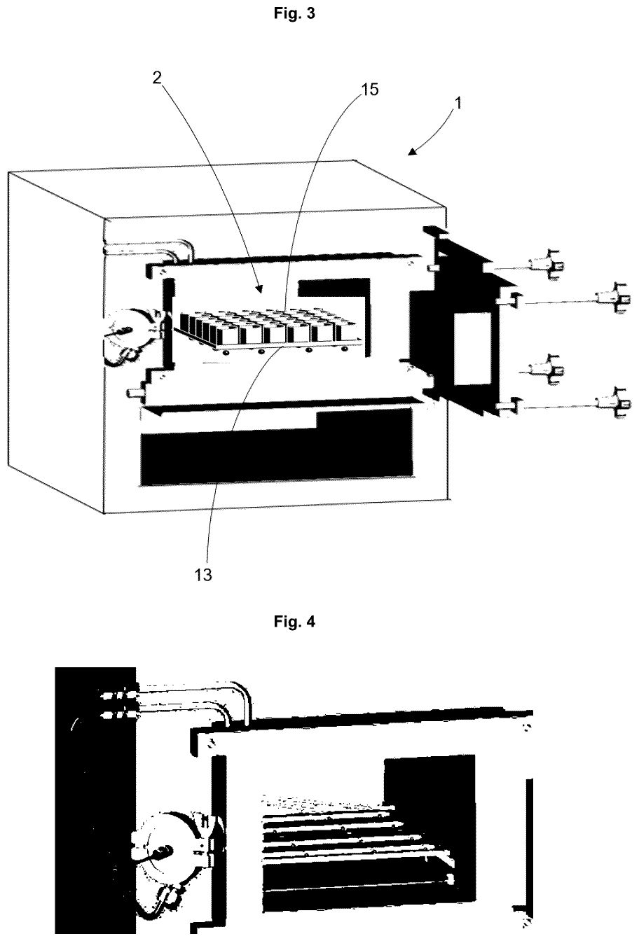

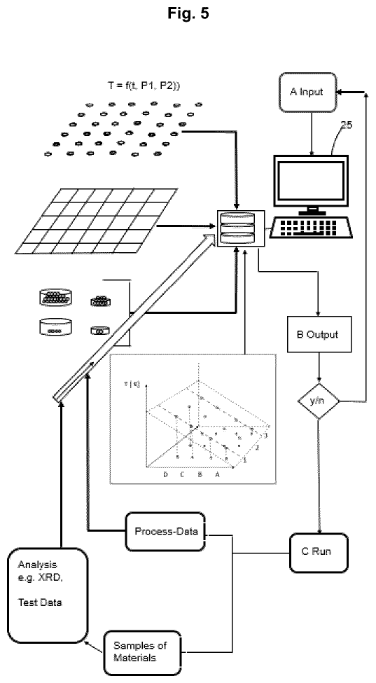

In FIG. 3, a combination of the elements from FIG. 1 and FIG. 2 is shown, wherein the positioning system 2 is located in the heat treatment zone of the furnace chamber. As shown in FIG. 2, the device comprises a sensor matrix with 16 temperature sensors and a positioning system with 36 sample containers.

In FIG. 4, a detail of the device represented in FIG. 1 is shown, wherein the details of the front side of the device can be seen.

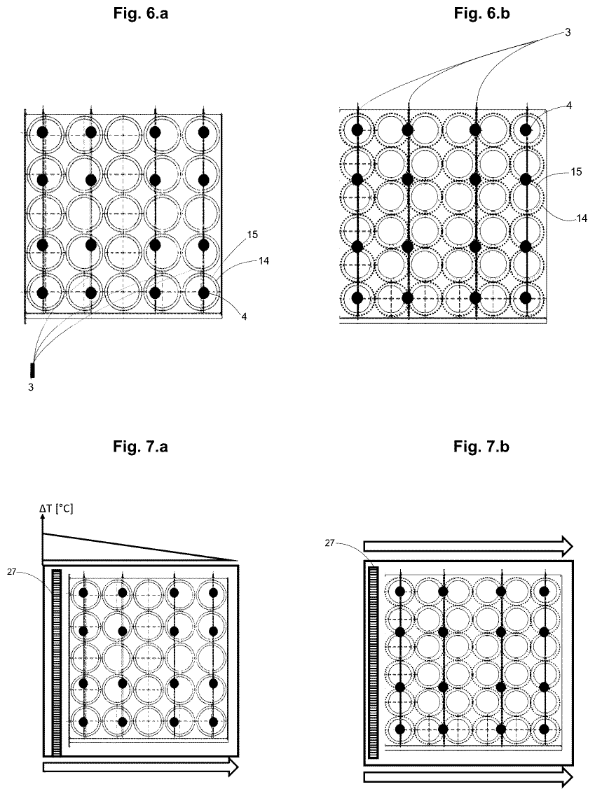

In FIGS. 6.a and 6.b, schematic representations are shown in the overlay of illustrations of how the sensor matrix and positioning system are arranged, wherein a positioning system for 25 sample containers is shown in FIG. 6.a and a positioning system of 36 sample containers is shown in FIG. 6.b. In both cases, the device is equipped with a sensor matrix which is symmetrical and comprises 4×4 temperature sensors, thus 16 temperature sensors.

In FIGS. 7.a and 7.b, the schematic representations are given which are also shown in FIGS. 6.a and 6.b, wherein the devices also have the additional temperature conditioning elements 27, which form the temperature gradient in the plane of the positioning system, a result of which is that the temperature zones for certain rows of sample containers are almost identical and the temperature of the successive rows either rises or falls. In FIG. 7.a, a decrease in temperature along the rows can be seen, which is caused by the fact that by means of the additional temperature conditioning element 27, a heating takes place which decreases as a function of the distance from the heat source.

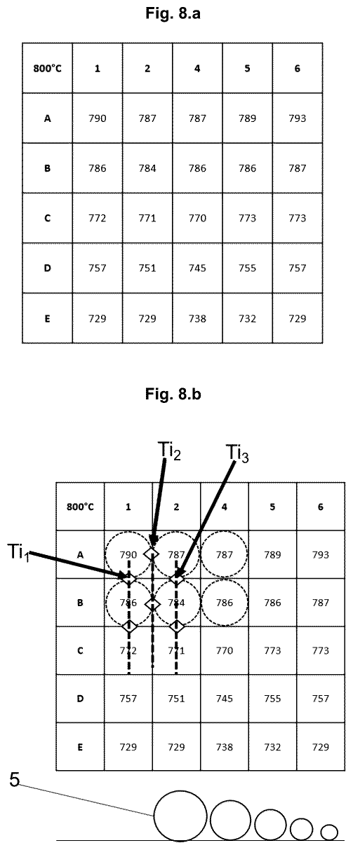

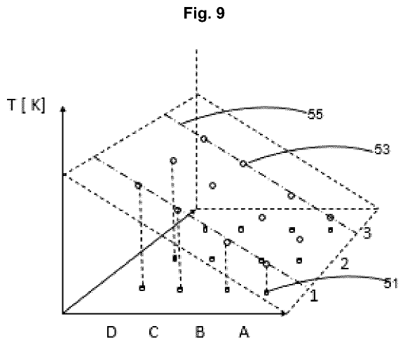

In FIGS. 8.a and 8.b, schematic representations of a temperature sensor matrix with 5×5 measuring sites or temperature values are given, which were achieved in conjunction with a temperature gradient of 60 K, wherein the total temperature of minimum and maximum temperature value was in the range of 730 K to 790 K. It should be pointed out that here a multiplicity of samples can be treated at very different temperature values. In the present case, five samples each at five different temperature values. FIG. 8.b illustrates that the accuracy is also influenced by the interaction of the different parameters. For example, by the number of temperature sensors in the sensor matrix and by the size of the respective sample containers. In addition, the size of the temperature gradient also plays a role.

### Examples of Performing Calibration of the Device

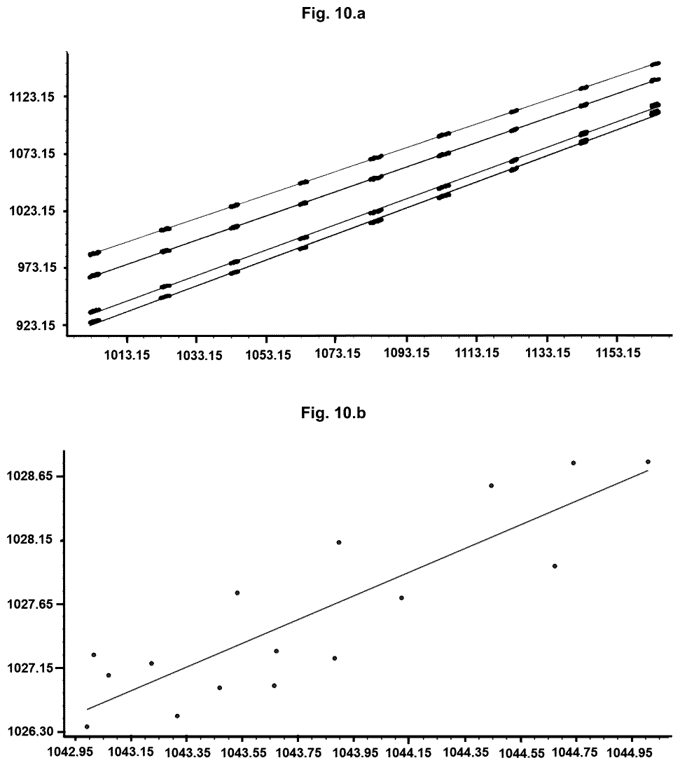

With the device according to the invention, investigations were carried out for the calibration of the interior of the device, wherein the device used here was equipped with a temperature conditioning element in the form of a cooling device, which was arranged in the door region of the device. In the interior of the device, a sensor matrix with 4×4 temperature sensors (a total of 16 temperature sensors) was positioned, which were arranged at defined points in the plane of the positioning system. Sensor matrix was connected to a process computer. The temperature conditioning element was connected to a water-operated cooling thermostat. In the present case, the cooling thermostat used was equipped with its own controller. Preferably, the cooling thermostat is connected to the process computer. When the calibration is carried out, the device is adjusted to different temperature levels, where cooling fluid is simultaneously passed through the temperature conditioning element, so that a temperature gradient is developed, specifically in the form of a temperature slope in the direction of the temperature conditioning element. During calibration, the device was set to nine different setpoint temperatures and the temperatures at the sixteen temperature sensors were recorded. In the example, the setpoint temperature was increased by 20 K in each case. Calibration data for the temperature range from 1003.15 K to 1163.15 K are shown in FIG. 10.a, where the increasing of the setpoint temperature can be seen in the x-axis. FIG. 10.a shows the results of the measurement data for four different positions in the interior of the device. A graphical representation of all the temperature values at all sixteen positions would be too confusing owing to the large number of measurement data. At the setpoint temperature of 1003.15 K, the temperature gradient within the interior of the device is 65 K and at a setpoint temperature of 1163.15 K, the temperature gradient within the interior of the device is 41 K. In FIG. 10.b, a magnified detail for a single spatial position within the interior of the device is shown for a setpoint temperature of 1043.15 K. The basic elements of a device for heat treatment also include heating conductors, controllers and at least one base temperature measurement sensor. Preferably, the basic elements are integrated into the process control of the device according to the invention. The base temperature measurement sensor or sensors are used to control the base temperature of the device. Depending on the design of the device, the base temperature measurement sensor is a temperature sensor which forms a temperature sensor of the sensor matrix. The specification of the setpoint temperature refers here to the temperature of the base temperature measurement sensor, which serves as a central measurement sensor for setting or controlling the heating conductors of the device. Therefore, the base temperature measurement sensor is also referred to as the central temperature measurement sensor.

The temperature control of the furnace causes a control noise of +/−1K, i.e., the temperatures fluctuate temporally by a maximum of +/−1 K. The control noise continues to the individual spatial positions. In this case, temperature measurement values could be detected with a precision of <0.1 K and correlated with a statistical correlation coefficient of R>0.99 to the respective expected value. The expected value is calculated from the modeling of the calibration data.

### Examples of Performing Thermal Treatment of Samples

In two runs, sample materials respectively in 25 containers and in 36 containers were subjected to thermal treatment, with the containers and the samples contained in them being simultaneously exposed to different temperatures. This took place respectively in different runs for the sample materials in the 25 containers and the sample materials in the 36 containers. The chosen duration for the thermal treatment was 10 hours. The sample materials were pulverulent precipitation products of mixed oxides, which form a crystal structure during thermal treatment.

Compositions of mixed oxide powders were selected in which the sizes of the crystallites forming depend on the temperature of the thermal treatment to which the sample materials are subjected. After conclusion of the thermal treatment, the sample materials were subjected to an analytical characterization in which the crystallite sizes of the individual samples were ascertained by an X-ray analytical method, by means of structural refinement with the Rietveld method using standards. Both internal reflections and samples prepared independently of the performance of the method described here were used as standards. The crystallite sizes obtained show a correlation with the target temperature and corresponding reference samples. The crystallite sizes obtained show a correlation with the target temperature. A statistical analysis of the data showed that the crystallite sizes of the samples could be correlated with the measurement data from the thermal treatment with a correlation coefficient of R²>0.95.

The example illustrates some of the advantages of the invention: with a few runs, it was possible to thermally treat a large number of sample materials simultaneously at different temperatures. The accuracy in the performance of the thermal treatment could be controlled very precisely, with the measurement data being acquired by the process control and utilizable as information for future measurements. These advantages are of particular interest in the field of high-throughput research, as it is important here to produce a large number of samples simultaneously in an efficient manner.

### LIST OF REFERENCE SIGNS

1 device for heat treatment
2 positioning system with containers
3 sensor matrix
4, 4′, 4″ temperature sensors
5 plug-in device
6 housing device for heat treatment
7 additional temperature conditioning device
9 supply line/connecting line to temperature sensors
11 supply line to additional temperature conditioning device
13 positioning system
14 receiving position for container
15 container
21 hinged door
23 mechanical locking system
25 measuring and control facility in the form of a computer
27 fill level measuring device
51 tip of a temperature sensor
53 temperature at measurement position
55 interpolated line, presently linearly interpolated

1. A device for heat treatment of materials, comprising:
at least one thermally insulated door equipped with a folding or sliding mechanism;
a temperature-conditionable interior comprising a thermal treatment zone;
a sensor matrix of temperature sensors, and
a measurement and control unit;
wherein:
the device is lockable;
the sensor matrix comprises a multiplicity of temperature sensors, which are arranged at different points within the temperature-conditionable interior of the device; and
the number of temperature sensors is ≥4.

2. The device for heat treatment of materials according to claim 1, wherein the temperature-conditionable interior has a width in the range of 10 to 100 cm, a height in the range of 5 to 50 cm and a depth in the range of 10 to 100 cm.

3. The device for heat treatment of materials according to claim 1, wherein:
the device comprises a positioning system for receiving containers; and
the position system comprises a number of containers is in the range of 4 to 256, or the positioning system has a number of recesses in the range of 4 to 256.

4. The device for heat treatment of materials according to claim 1, wherein the temperature sensors are arranged in a symmetrical group or at least partially in a plane surface.

5. The device for heat treatment of materials according to claim 1, comprising an additional temperature conditioning element configured to heat or cool at least a partial region of a thermal treatment zone of the device.

6. The device for heat treatment of materials according to claim 1, comprising:
one or more suction lances; and
an analyzer;
wherein:
the suction lances are connected by lines to the analyzer; and
end points of the suction lances are arranged in the interior of the device.

7. The device for heat treatment of materials according to claim 5, wherein the additional temperature conditioning element is rod-shaped or sheetlike.

8. A method for heat treatment of materials in the device according to claim 1, the device further comprising a positioning system for receiving containers, when the device comprises or is connected to a database for acquisition and analysis of method parameters, the method comprising:
introducing materials into containers;
positioning the filled containers in receiving positions of the positioning system;
transferring the positioning system populated with containers to the thermal treatment zone of the device;
storing the positioning system in the thermal treatment zone; and
acquiring test parameters;
wherein:
the test parameters comprise information on the individual materials in the form of sample identification numbers and their spatial arrangement in relation to the respective receiving positions within the positioning system; and
when the positioning system is stored in the treatment zone, measurement data on the temperature of the individual temperature sensors are registered as a function of time by the sensor matrix.

9. The method for heat treatment of materials according to claim 8, comprising:
recording of data on the positions of the individual temperature sensors within the temperature-conditionable interior in the database;
recording of data on the positioning system in the database, these data including the position of the individual surface of the positioning system and the dimensions of the individual containers;
storing of the positioning system in the thermal treatment zone in the case of temperature conditioning of the interior at a temperature in the range of 473.15 to 2073.15 K for a selected period of time, wherein the temperature conditioning of the interior is carried out by means of a single control unit in a way such that the device is temperature conditioned at a unitary target temperature with respect to the surface of the positioning system;
registering of the temperature measurement values determined by means of the individual temperature sensors in the database, together with position datum and time datum during the performance of the temperature conditioning; and
assigning of the local temperature measurement values to the individual containers whose surface region overlaps with the local temperature sensors or for which the temperature sensors are nearby, wherein for the assignment, the temperature measurement values are adapted if adjacent temperature measurement values exhibit a temperature difference, and the temperature measurement values assigned to the containers are assigned to the materials contained in the containers, the values being stored in the database under an identification number characteristic of the respective container and the material arranged therein.

10. The method for heat treatment of materials according to claim 9, wherein the device comprises an optimization algorithm and a program controller, and the program controller provides a selection of parameters provided from the group of the number of samples to be subjected to a thermal treatment, the amount of samples and the value of the target temperature at which the thermal treatment is to be carried out, and the magnitude of the accuracy is determined using at least one parameter, the accuracy being given by ΔK or delta in kelvins.

11. The method for heat treatment of materials according to claim 10, wherein the measurement data ascertained by means of the sensor matrix are correlated, wherein the values in the space between adjacent temperature sensors are determined mathematically and the ascertained measurement data from the temperature sensors are assigned to the receiving positions and the containers arranged in the receiving positions.

12. The method for heat treatment of materials according to claim 8, wherein:
the device comprises an additional temperature conditioning element configured to heat or cool at least a partial region of a thermal treatment zone of the device; and
the thermal treatment zone is heated or cooled by means of the additional temperature conditioning element, wherein the additional temperature conditioning element is monitored with a separate open-loop or closed-loop control element, which is connected to the measuring and control unit of the device and thus also to the data storage device; the additional temperature conditioning element causes the generation of a temperature gradient field in the interior of the device, preferably the temperature gradient field is aligned parallel to the surface of the positioning system, wherein in the method the containers in the receiving positions of the positioning system are stored at different temperature values, wherein the measurement data from the individual temperature sensors exhibit temperature deviations ≤5 K.

13. The method for heat treatment of materials according to claim 12, wherein the temperature-conditionable interior is heated to a target temperature and a gradient field is generated by means of the additional temperature conditioning element; wherein the temperature measurement values measured at the individual temperature sensors are stored together with the set open-loop and closed-loop control parameters in the database, wherein the respective configuration of target temperature in combination with open-loop and closed-loop control parameter determines the structure of the temperature gradient field within the temperature-conditionable interior, wherein the gradient field surface preferably has a monotonic profile and is characterized by a linear incline or decline.

14. The method for heat treatment of materials according to claim 13, wherein the amount and number of materials and the temperature levels at which the temperature conditioning is to be carried out are specified and the method comprises a computer program which uses the values stored in the database to ascertain a program sequence for performing the method, wherein the specification of parameters preferably also includes a datum on the temperature variation which is not to be exceeded, wherein the slope of the temperature gradient is related to the diameter of the bottom surface of an individual container, wherein the computer program is preferably also able to indicate the suitable container size to be used for performing the temperature conditioning.

15. The method for heat treatment of materials according to claim 8, wherein the method comprises:
characterizing materials obtained in the heat treatment with respect to performance properties; and
storing parameters characterizing the performance properties in the database.

16. The method for heat treatment of materials according to claim 15, comprising:
evaluating data with respect to the performance properties by determining magnitude of accuracy; and
comparing the data with respect to the performance properties with data and/or information taken from the database which were not achieved during the performance of the method or in an earlier performance of the method.

17. The method for heat treatment and characterization of materials according to claim 8, wherein:
the method comprises heat treatment in production of a material selected from the group consisting of a catalyst, a battery material, a high-performance ceramic, and an inorganic semiconductor material;
the method comprises subjecting a material to a temperature conditioning treatment;
the method comprises storing data on the type of material and treatment in the database; and
data on each treatment step performed are registered in a manner such that the material being treated receives a corresponding identification number which is stored in the database.

18-19. (canceled)
